(19) United States
(12) Patent Application Publication
(10) Pub. No.: US 2025/0233766 A1
(43) Pub. Date: Jul. 17, 2025

(54) SYSTEMS AND METHODS FOR DYNAMIC GROUPING FOR MULTICAST COMMANDS WITHIN A UTILITY SYSTEM

(71) Applicant: Aclara Technologies LLC, St. Louis, MO (US)

(72) Inventor: David Donald Haynes, St. Peters, MO (US)

(21) Appl. No.: 19/017,113

(22) Filed: Jan. 10, 2025

Related U.S. Application Data
(60) Provisional application No. 63/620,556, filed on Jan. 12, 2024.

(51) Int. Cl. H04L 12/18; H04L 67/12

(52) U.S. Cl. CPC H04L 12/185; H04L 67/12

(57) ABSTRACT

A utility system includes a number of electrical meters, a number of load devices, and a utility controller. The utility controller is configured to receive a command and an associated managerial group and determine a number of target devices based on the received managerial group. The target devices include one or more of the electrical meters and load devices. The utility controller is further configured to determine a first optimal communication group of a number of communication groups associated with the utility system. The first optimal communication group includes one or more of the determined target devices. The utility controller is also configured to issue the received command to the determined optimal communication group.

### CROSS-REFERENCE TO RELATED APPLICATIONS

This application claims priority to, and the benefit of, U.S. Provisional Patent Application No. 63/620,556 filed Jan. 12, 2024, the entire contents of which are incorporated herein.

### FIELD

The embodiments disclosed herein relate to systems and methods for allowing for dynamic grouping of utility devices, such as meters, load devices, etc. for facilitating directed multicast command transmission and processing.

### BACKGROUND

Historically, communication systems base their addressing on something as simple as an IP address. A “multicast” address could be used to address a “group”, but this group is generally generic in nature, or perhaps based on device type. As more advanced communication systems became available, such as TWACS® from Aclara, Inc., these systems developed more sophisticated addressing modes known as “FGU” and “XY” addressing. FGU addressing is used for two-way commands to address groups. These groups are often organized by electrical location within the network. A request sent out to the group is met with a response that supplies data or an acknowledgement of the command. However, it is not possible to customize the group membership on-the-fly. XY addressing is used for one-way commands (in the broadcasting of commands). These groups are often organized by load type (in one dimension) and connectivity or area (in the other dimension.) XY addressing is very useful for load control applications, but, being a one-way mechanism, does not support an acknowledgement of the command.

For example, in load control scenarios, there is a need for dynamic adjustment of groups of devices. For example, it may be necessary to select all of the hot water heaters in a given regions, or all of the air conditioners on a given feeder. Adjustments made to the group are generally within the control of an operator, which may make them in real time in an effort to curtail a given amount of load. Furthermore, load control, in addition to having day-ahead, hour-ahead, or future markets, may also include a real-time market requiring an ability to dynamically balance load within a utility system in real time. Thus, an ability to define groups for load control and optimally communicate commands to said groups would be advantageous. Furthermore, there is a desire to obtain acknowledgements from devices that receive the load control commands, and to run simulations within the network to test the effectiveness of the communication network and the effectiveness of the group assignments.

### SUMMARY

In one embodiment, a utility system is described, including a number of electrical meters, a number of load devices, and a utility controller. The utility controller is configured to receive a command and an associated managerial group and determine a number of target devices based on the received managerial group. The target devices include one or more of the electrical meters and load devices. The utility controller is further configured to determine a first optimal communication group of a number of communication groups associated with the utility system. The first optimal communication group includes one or more of the determined target devices. The utility controller is also configured to issue the received command to the determined optimal communication group.

In another embodiment, a process for issuing commands to devices within a utility system is described. The method includes receiving a command at a utility controller. The command includes a grouping of target devices within a utility system to execute the command. The process further includes determining, at the utility controller, a number of target devices within the utility system based on the received command. The process also includes determining a first optimal communication group of a number of communication groups associated with the utility system, wherein the first optimal communication group includes one or more of the determined target devices.

In another embodiment, a utility device is described. The utility device includes a communication interface and an electronic processor. The electronic processor is configured to receive a command via the communication interface, determine whether the received command is addressed to the utility device, process the command in response to determining that the received command is addressed to the utility device, and determine whether the command requires a synchronous response. The electronic processor is further configured to determine a response frequency and timeslot for responding to the command in response to determining that the command requires a synchronous response, determine whether the determined timeslot has occurred, and transmit, via the communication interface, a response to the command in response to determining the timeslot has occurred.

Other aspects of the technology will become apparent by consideration of the detailed description and accompanying drawings.

### BRIEF DESCRIPTION OF THE DRAWINGS

FIG. 1 is a system diagram illustrating a utility system, according to some embodiments.

FIG. 2 is a block diagram illustrating a utility controller, according to some embodiments.

FIG. 3 is block diagram of a meter within the utility system of FIG. 1, according to some embodiments.

FIG. 4 is a block diagram of a load device within the utility system of FIG. 1, according to some embodiments.

FIG. 5 is a flow chart illustrating a process for managerial group formation, according to some embodiments.

FIG. 6 is a flow chart illustrating a process for generating one or more communication groups, according to some embodiments.

FIG. 7 is a flow chart illustrating a process for group optimization, according to some embodiments.

FIG. 8 is a class diagram illustrating data structure types of structures within a utility system, according to some embodiments.

FIG. 9 is a block diagram illustrating a process for application layer acknowledgement, according to some embodiments.

FIG. 10 is a timing diagram illustrating a relationship between response windows and start delays when transmitting in a synchronous mode, according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. As used within this document, the word “or” may mean inclusive or. As a non-limiting example, if examples in this document state that “item Z may comprise element A or B,” this may be interpreted to disclose an item Z comprising only element A, an item Z comprising only element B, as well as an item Z comprising elements A and B.

As used herein, “meter” may refer to a connected utility meter, an end point, an end device, an advanced metering infrastructure (“AMI”) meter from Aclara Technologies®, a meter communication add-on, or other metering device as required for a given application.

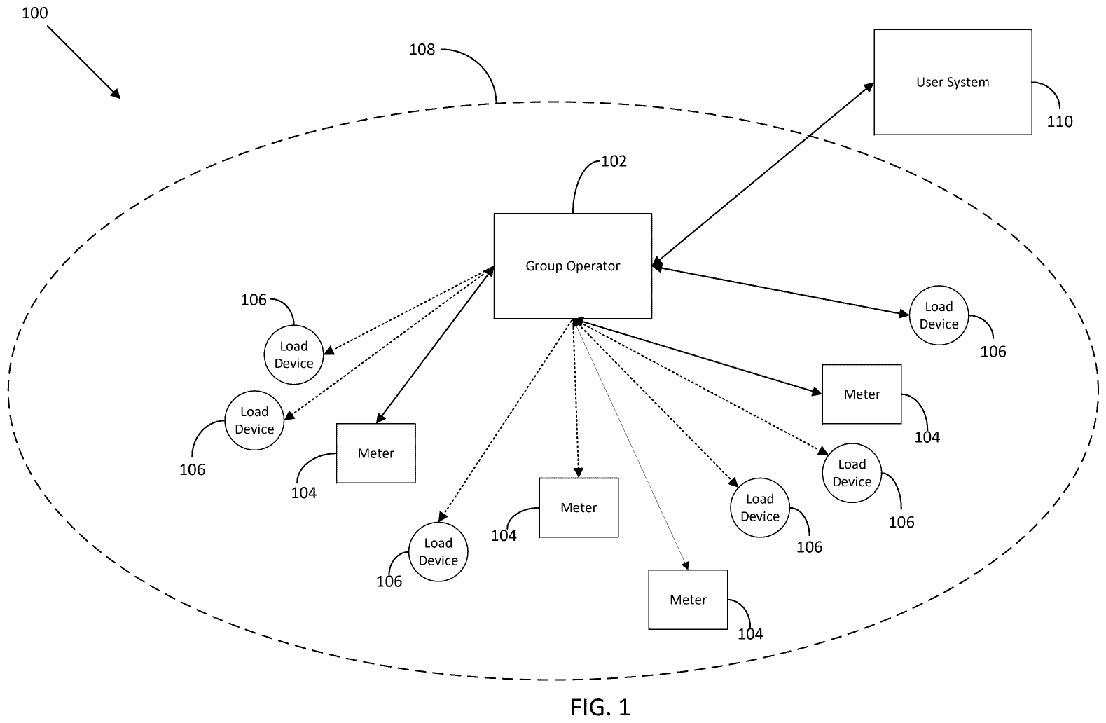

FIG. 1 illustrates an example utility system 100, according to some embodiments. It is understood that the utility system 100 is for example purposes and that utility systems may include more or fewer components, as described below. The utility system 100 includes a group operator 102. In some examples, the group operator 102 may be referred to as a central utility controller, a utility controller, etc. The group operator 102 is configured to manage and control communication and/or operations of various connected devices, such as one or more meters 104 and/or load devices 106. However, other connected devices are also contemplated, as required for a given application. The meters 104 may be general solid state electric utility meters, smart meters (i.e., connected), and/or other meter types as required for a given application. The meters 104 may be residential meters, commercial meters, industrial meters, municipality meters, and/or other meters as required for a given application. The load devices 106 may include various devices used to control a load on an electrical utility system, such as utility system 100. For example, load devices may include connected appliances or other household components, such as hot water heaters, refrigerators, pool heaters, pool pumps, hot tubs, air conditioning units, and/or other electrical load device as required for a given application. The load devices 106 may be configured to allow for remote operation for disconnecting the load devices 106 to reduce a strain on a power grid or utility system. In other examples, the load devices 106 may be industrial devices that are connected to the utility system 100 and configured to be able to be disconnected to reduce a strain on the power grid. For brevity purposes, every type of load device 106 is not described herein, but it is understood that the load devices may include any electrical load devices within a utility system, such as utility system 100.

Furthermore, while the system 100 is shown with respect to meters 104 and load devices 106, it is contemplated that multiple other devices may be used in the system 100, such as sensors (methane sensors, water pipe lead sensors, sewer overflow sensors, conductor sensors, etc.) and/or any other device that may be utilized within a utility system. Accordingly, the meters and load devices described herein are for exemplary purpose and are understood not to be limiting.

The group operator 102 may be configured to communicate with the meters 104 and/or load devices 106 over a wide area communication network 108. The communication network 108 may utilize one or more communication protocols to provide communication between the group operator 102 and the meters 104 and/or load devices 106. Example communication protocols may include Bluetooth, Bluetooth Low Energy (“BLE”), Cellular (e.g., 3G, 4G, 5G, LTE, CDMA, TDMA, etc.), RF, Wi-Fi, LoRa, LoRaWAN, Z-wave, Thread, Zigbee, Matter, or proprietary communication protocols such as Aclara RF. However, other communication protocols are also contemplated as required for a given application.

The utility system 100 may further include a user system 110. The user system 110 may be one or more third-party systems, such as load management systems, equipment suppliers, alternative energy suppliers, billing service provider, and/or other third parties as required for a given application. In other examples, the user system 110 may be associated with the utility provider, and therefore associated with the group operator 102. The user system 110 may be configured to communicate with the group operator 102 to enact various operations of the associated meters 104 and/or load devices 106, such as reading meter data, disconnecting power to loads associated with meters, and/or controlling load devices 106 to allow for load on the utility system to be reduced.

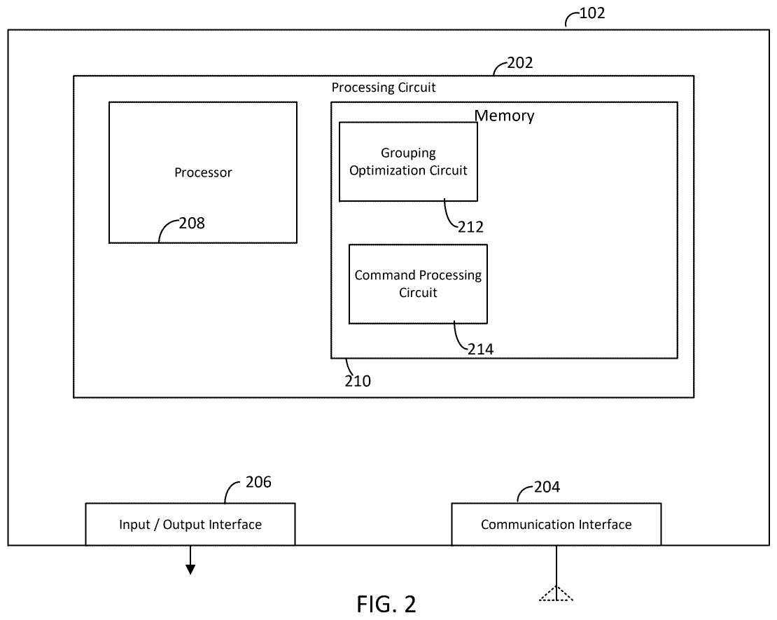

Turning now to FIG. 2, a block diagram illustrating an example group operator 102 is shown, according to some embodiments. As shown in FIG. 2, the group operator includes a processing circuit 202, a communication interface 204, and an input/output (I/O) interface 206. The processing circuit 202 includes an electronic processor 208 and a memory 210. The processing circuit 202 may be communicably connected to one or more of the communication interface 204 and the I/O interface 206. The electronic processor 208 may be implemented as a programmable microprocessor, an application specific integrated circuit (ASIC), one or more field programmable gate arrays (FPGA), a group of processing components, or with other suitable electronic processing components.

The memory 210 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory 210 may include database components, object code components, script components, or other types of code and information for supporting the various activities and information structure described in the present application. According to one example, the memory 210 is communicably connected to the electronic processor 208 via the processing circuit 202 and may include computer code for executing (for example, by the processing circuit 202 and/or the electronic processor 208) one or more processes described herein.

The communication interface 204 is configured to facilitate communication between the group operator 102 and one or more external devices or systems, such as meters 104, load devices 106, the user system 110, and/or other devices as required for a given application. In one embodiment, the communication interface 204 facilitates the communication network 108 using one or more communication protocols. The communication interface 204 may be, or include, wireless communication interfaces (for example, antennas, transmitters, receivers, transceivers, etc.) for conducting data communications between the group operator and one or more external devices, such as those described above. In some embodiments, the communication interface 204 utilizes a proprietary protocol for communicating with other devices. For example, the proprietary protocol may be an RF-based protocol configured to provide efficient and effective communication between the group operator 102 and other devices, such as AclaraRF. In other embodiments, other wireless communication protocols may also be used, such as cellular (3G, 4G, 5G, LTE, CDMA, etc.), Wi-Fi, LoRa, LoRaWAN, Z-wave, Thread, and/or any other applicable wireless communication protocol.

The I/O interface 206 may be configured to interface directly with one or more devices, such as a power supply, other communication equipment, etc. In one embodiment, the I/O interface 206 may utilize general purpose I/O (GPIO) ports, analog inputs, digital inputs, etc.

As described above, the memory 210 may be configured to store various processes, layers, and modules, which may be executed by the electronic processor 208 and/or the processing circuit 202. In one embodiment, the memory 210 includes a grouping optimization circuit 212 and/or a command processing circuit. The grouping optimization circuit 212 may be configured to optimize a communication group of associated end devices (e.g., meters 104, load devices 106, and/or other devices as required for a given application), as will be described in more detail below. The command processing circuit 214 may be configured to process one or more commands received from various devices and/or circuits, such as the grouping optimization circuit 212, a user system 110, and/or other devices as required for a given application.

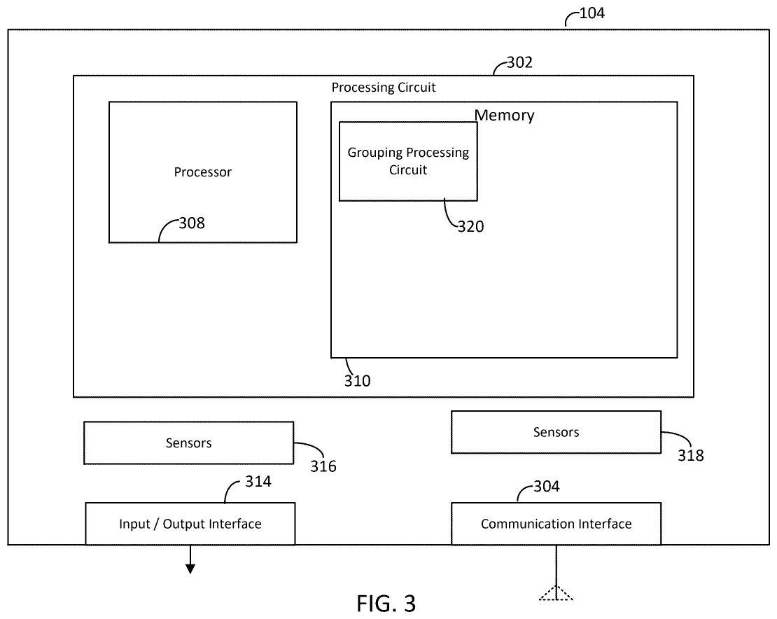

Turning to FIG. 3, a block diagram of a meter, such as meter 104, is shown according to some embodiments. As shown in FIG. 3, the meter 104 includes a processing circuit 302, a communication interface 304, an input/output (I/O) interface 314, and one or more sensors 316. The processing circuit 302 includes an electronic processor 308 and a memory 310. The processing circuit 302 may be communicably connected to one or more of the communication interface 304 and the I/O interface 314. The electronic processor 308 may be implemented as a programmable microprocessor, an application specific integrated circuit (ASIC), one or more field programmable gate arrays (FPGA), a group of processing components, or with other suitable electronic processing components.

The memory 310 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory 310 may include database components, object code components, script components, or other types of code and information for supporting the various activities and information structure described in the present application. According to one example, the memory 310 is communicably connected to the electronic processor 308 via the processing circuit 302 and may include computer code for executing (for example, by the processing circuit 302 and/or the electronic processor 308) one or more processes described herein.

The communication interface 304 is configured to facilitate communication between the meter 104 and one or more external devices or systems, such as the group operator 102, one or more other meters 104, and/or one or more load devices 106. The communication interface 304 may be, or include, wireless communication interfaces (for example, antennas, transmitters, receivers, transceivers, etc.) for conducting data communications between the meter 104 and one or more external devices, such as another meter 104, one or more load devices 106, and/or the group operator 102. In some embodiments, the communication interface 304 utilizes a proprietary protocol for communicating with other meters 104, one or more load devices 106, and/or the group operator 102. For example, the proprietary protocol may be an RF-based protocol configured to provide efficient and effective communication between the meters 104 and other devices. In other embodiments, other wireless communication protocols may also be used, such as cellular (3G, 4G, 5G, LTE, CDMA, etc.), Wi-Fi, LoRa, LoRaWAN, Z-wave, Thread, and/or any other applicable wireless communication protocol.

The I/O interface 314 may be configured to interface directly with one or more devices, such as a power supply, a power monitor, etc. In one embodiment, the I/O interface 314 may utilize general purpose I/O (GPIO) ports, analog inputs, digital inputs, etc. The sensors 316 may include one or more sensors configured to monitor one or more aspects of a distribution line coupled to the meter 104. For example, the sensors 316 may include voltage sensors, current sensors, temperature sensors, and other sensors as required for a given application. In some embodiments, the sensors 316 include one or more connections between the meter 104 and an electrical utility line. In other examples, the sensors 216 may be connected to the electrical utility line using the I/O interface 314.

The meter 104 may further include a location system 318. The location system 318 may provide location data of the meter 104. In some examples, the location system 318 may utilize geolocation satellite data (e.g., GPS, GLONASS, etc.) to determine a location of the meter 104. However, other location determination technologies (e.g., cellular triangulation, Wi-Fi location, or other location service required for a given application) may also be used by the location system 318.

As described above, the memory 310 may be configured to store various processes, layers, and modules, which may be executed by the electronic processor 308 and/or the processing circuit 302. In one embodiment, the memory 310 includes a grouping processing circuit 320. The grouping processing circuit 320 is configured to determine whether the meter 104 is the intended target of a unicast group message.

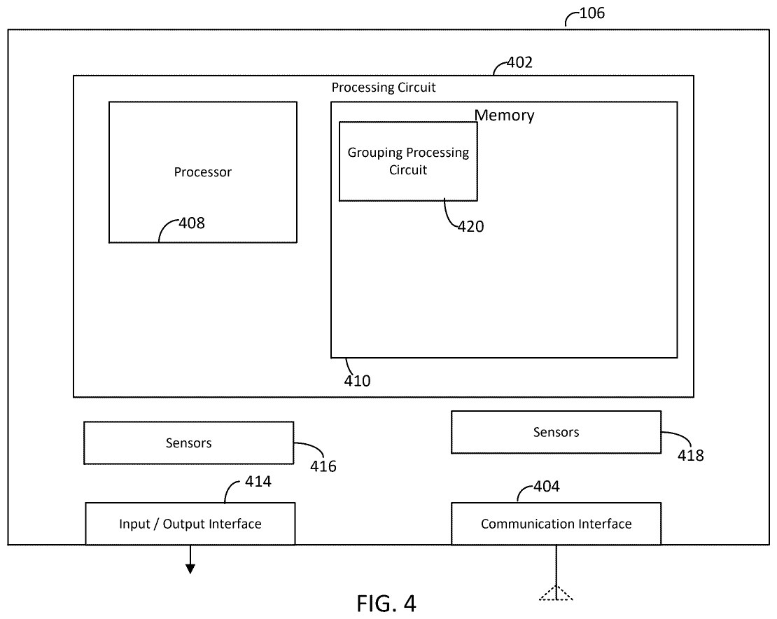

Turning now to FIG. 4, a block diagram of a load device, such as load device 106, is shown according to some embodiments. As shown in FIG. 4, the load device 106 includes a processing circuit 402, a communication interface 404, an input/output (I/O) interface 414, and one or more sensors 416. The processing circuit 402 includes an electronic processor 408 and a memory 410. The processing circuit 402 may be communicably connected to one or more of the communication interface 404 and the I/O interface 414. The electronic processor 408 may be implemented as a programmable microprocessor, an application specific integrated circuit (ASIC), one or more field programmable gate arrays (FPGA), a group of processing components, or with other suitable electronic processing components.

The memory 410 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory 410 may include database components, object code components, script components, or other types of code and information for supporting the various activities and information structure described in the present application. According to one example, the memory 410 is communicably connected to the electronic processor 408 via the processing circuit 402 and may include computer code for executing (for example, by the processing circuit 402 and/or the electronic processor 408) one or more processes described herein.

The communication interface 404 is configured to facilitate communication between the load device 106 and one or more external devices or systems, such as the group operator 102, one or more other load devices 106, and/or one or more meters 104. The communication interface 404 may be, or include, wireless communication interfaces (for example, antennas, transmitters, receivers, transceivers, etc.) for conducting data communications between the load device 106 and one or more external devices, such as the group operator 102, one or more other load devices 106, and/or one or more meters 104. In some embodiments, the communication interface 404 utilizes a proprietary protocol for communicating with other load device 106, one or more load meters 104, and/or the group operator 102. For example, the proprietary protocol may be an RF-based protocol configured to provide efficient and effective communication between the load device 106 and other devices. In other embodiments, other wireless communication protocols may also be used, such as cellular (3G, 4G, 5G, LTE, CDMA, etc.), Wi-Fi, LoRa, LoRaWAN, Z-wave, Thread, and/or any other applicable wireless communication protocol.

The I/O interface 414 may be configured to interface directly with one or more devices, such as a power supply, an appliance, a power relay, etc. In one embodiment, the I/O interface 414 may utilize general purpose I/O (GPIO) ports, analog inputs, digital inputs, etc. The sensors 416 may include one or more sensors configured to monitor one or more aspects of a distribution line coupled to the load device 106. For example, the sensors 416 may include voltage sensors, current sensors, temperature sensors, and other sensors as required for a given application. In some embodiments, the sensors 416 include one or more connections between the load device 106 and an associated load. In other examples, the sensors 416 may be connected to an electrical load using the I/O interface 414.

The load device 106 may further include a location system 418. The location system 418 may provide location data of the load device 106. In some examples, the location system 418 may utilize geolocation satellite data (e.g., GPS, GLONASS, etc.) to determine a location of the load device 106. However, other location determination technologies (e.g., cellular triangulation, Wi-Fi location, or other location service required for a given application) may also be used by the location system 418.

As described above, the memory 410 may be configured to store various processes, layers, and modules, which may be executed by the electronic processor 408 and/or the processing circuit 402. In one embodiment, the memory 410 includes a grouping processing circuit 420. The grouping processing circuit 420 is configured to determine whether the load device 106 is the intended target of a unicast group message.

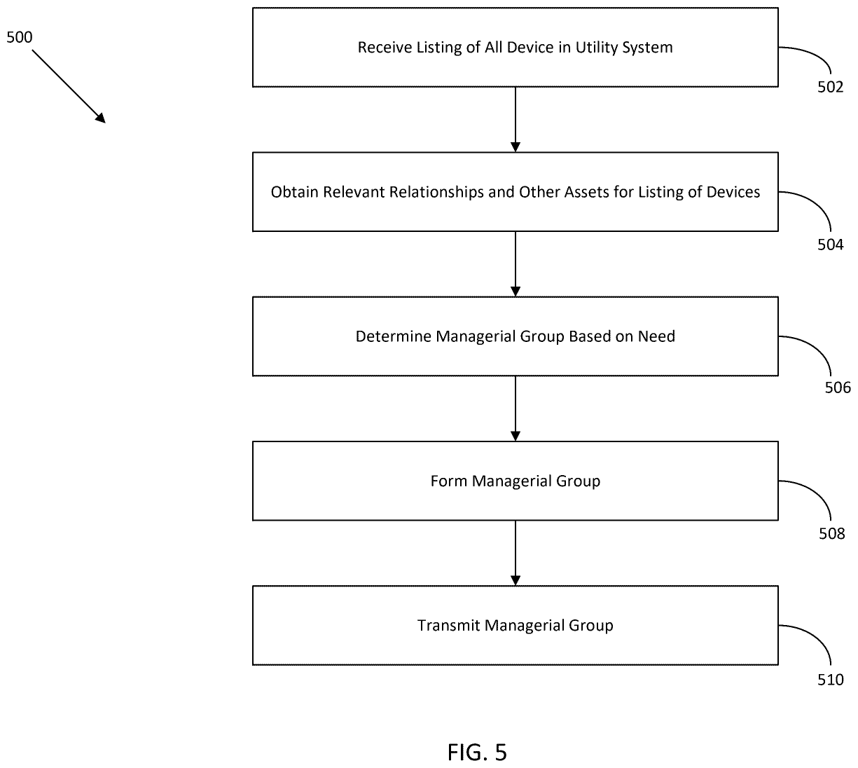

Turning now to FIG. 5, a process 500 for managerial group formation is shown, according to some embodiments. Managerial groups are generally groups of devices that are selected for the discussion of a particular subject, or to perform a specified task. Examples of a particular subject may be the provision of certain data, such as load data. Generally, a user system, such as user system 110 forms and/or determines which devices are desired to be in a specific managerial group as well maintains said managerial group (e.g., maintains a list of devices within the managerial group). Any given device (e.g., meter 104, load device 106, and/or other applicable devices) may be in multiple managerial groups as is determined based on the need within the user system 110. Accordingly, the process 500 is generally understood to be completed by the user system 110. However, in other examples, the process 500 may be performed by the group operator 102, and/or other devices/systems as required for a given application.

At process block 502, the user system 110 receives a listing of all devices associated with a utility system, such as utility system 100. In one embodiment, the group operator 102 may provide the listing of all devices to the user system 110. The listing of devices may include meters 104, load devices 106, as well as other devices as required for a given application.

At process block 504, the user system 110 determines one or more relevant relationships between devices and/or other assets. For example, the user system 110 may determine which meters 104 and load devices 106 are associated with each other. Alternatively, load devices 106 may be determined to have relevant relationships such as being associated with the same residence or facility, similar load type, associated transformer assignment, and/or other relevant relationship as required for a given application. At process block 506, the user system 110 determines a managerial grouping of received devices based on a specific need. The specific need may be a desired load reduction, load control, billing requirement, service cancellation, meter reading, firmware updates, and/or any other applicable need for a given application. In one embodiment, the user system 110 may be configured to generate managerial groups based on any specific need as defined by the user system 110.

At process block 508, one or more managerial groups are formed based on the determined managerial grouping. Each device within a managerial group may have an identifier of each device, such as a master resource identifier (“mRID”). The formed managerial groups may include a group name and a membership roster consisting of device identifiers, such as mRIDs. Managerial groups may have other attributes such as “reason” (e.g., a purpose or reason behind the formation of the managerial group, a router affiliation, and/or other attribute as required for a given application. The one or more managerial groups are then transmitted to the group operator at process block 510.

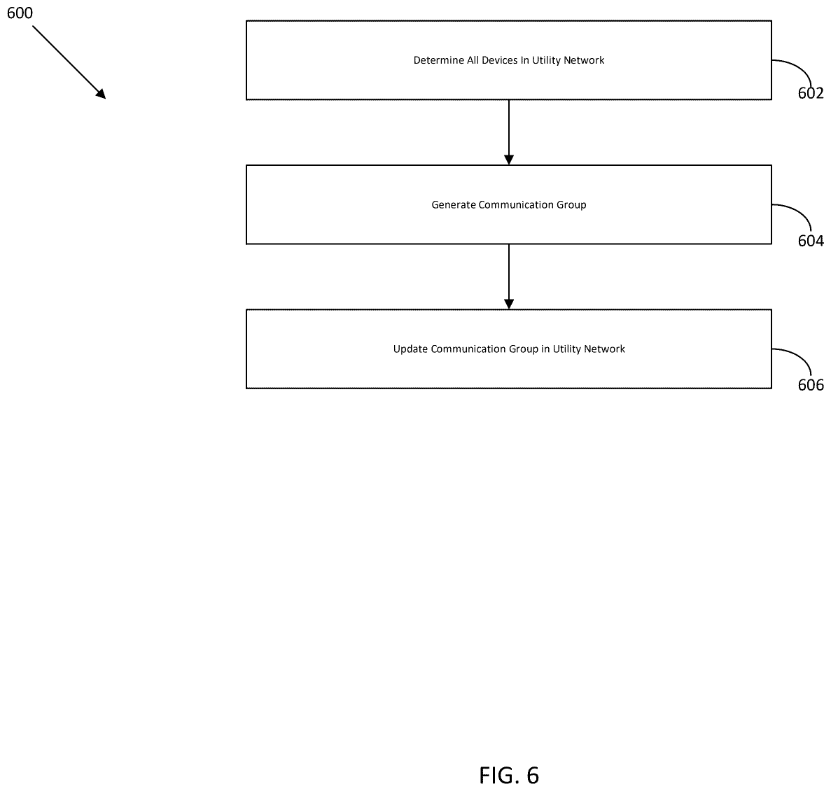

Turning now to FIG. 6, a process 600 for generating one or more communication groups is shown, according to some embodiments. Communication groups are groups of devices, such as meters 104 and/or load devices 106, within a utility system, such as utility system 100, and which are formed to allow for communication between the group operator 102 and the various devices within the utility system 100. Communication groups may be primarily generated for message routing purposes. In some examples, there may be a size limit for a particular communication group, which may be dictated by the technology used in the utility system. In other examples, multiple communication groups may be affiliated with the same routing path. In one embodiment, the process 600 is performed by the group operator, such as via the processing circuit 202. At process block 602, the group operator 102 determines all devices within a utility system, such as utility system 100. In some examples, the devices (e.g., meters 104, load devices 106, etc.) may all broadcast their identifiers (e.g., mRIDs) to the group operator 102 when initially connected. In other examples, the devices may continuously broadcast their identifiers. In still other examples, the group operator 102 may receive a list of devices within the utility system 100 from an external device or system when a new device is installed. For example, when a new device is installed within the utility system 100 the device is registered within the utility system 100.

At process block 604, one or more communication groups are generated. Communication groups may be formulated based on one or more characteristics of the associated devices, such as location, union and/or intersection characteristics, interconnection characteristics (e.g., common connection points), end user characteristics (e.g., same facility, group of facilities, etc.), and/or other parameters as required for a given application. Each communication group has an associated identification number. A communication group identification number may be written to each device within the communication so that the device is aware of its membership within a particular communication group. Further, each device (also referred to herein as an endpoint) is also given a unit number (“UnitNo”) within the communication group which represents the position of that device within the communication group.

In generating the communication groups, the group operator 102 may further generate an address map (“AddrMap”) that represents all of the UnitNos affiliated with the generated communication groups. UnitNos may have a specific order to them which may be leveraged in the formation of the AddrMap. For example, the specific order may be based on location, distance from the group operator 102, applications, and/or other parameters as required for a given application.

Upon generating the communication groups, a listing of communication groups within the group operator 102 is updated at process block 606.

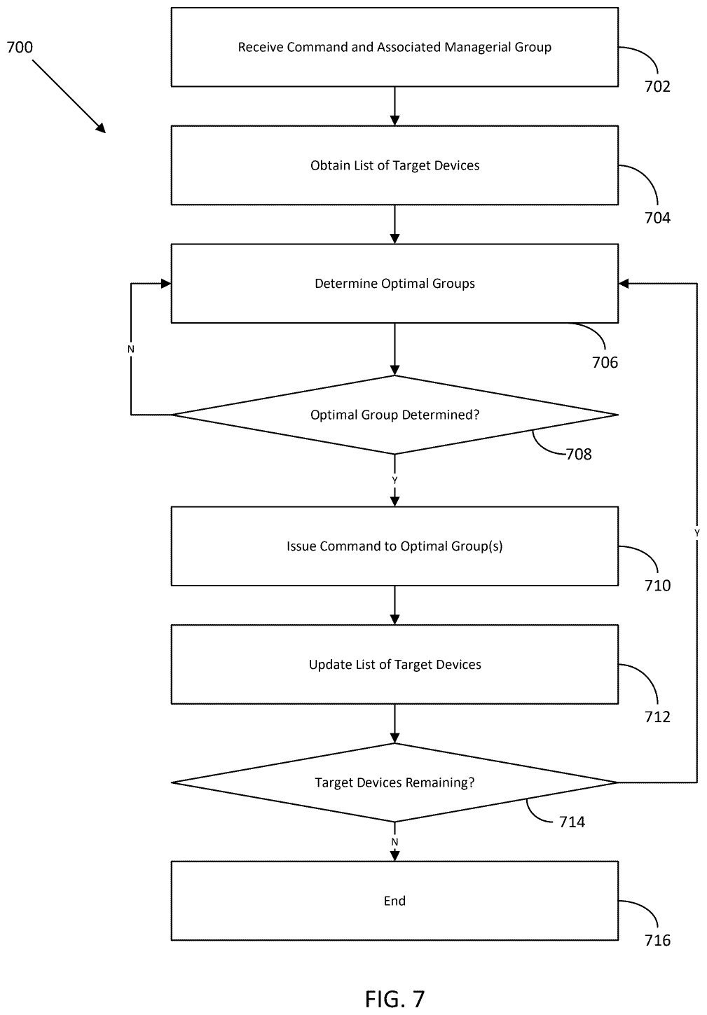

Turning now to FIG. 7, a process 700 for group optimization is shown, according to some embodiments. Group optimization may be utilized to allow for one or more communication groups to be used to provide a message to devices specified in a managerial group, such as those described above. For example, as will be described in more detail below, when a user system 110 issues a command or commands for distribution to a group of devices within a managerial group, the group operator 102 may refactor the managerial group into multiple communication groups to optimize the distribution of the commands to the associated devices. The commands may include various instructions, such as a request to report data, an instruction to disconnect a load, an instruction to connect a load, an instruction to disconnect or reconnect service, or any other command as required for a given application. Thus, the group operator 102, in some embodiments, performs the process 700 described below.

At process block 702, the group operator 102 receives a command and an associated managerial group to which the command is directed. In some examples, the command and associated managerial group is received from the user system 110. At process block 704, the group operator obtains a list of target devices within the utility system 100 based on the received command and associated managerial group. In one embodiment, the group operator 102 performs one or more union and intersection operations to obtain the list of target devices. For example, the group operator 102 may correlate the list of devices within the managerial group to the devices both within the utility system 100, as well as within one or more communication groups associated therewith. In other examples, the group operator 102 determines what devices within the received managerial group exist within the utility system 100. While union and intersection operations are described above, it is understood that other correlation and/or probability operations may be performed to obtain a list of targets based on the received command and associated managerial group.

At process block 706, the group operator 102 evaluates the previously generated communication groups against the list of targets in the received managerial group to determine an optimal grouping of target devices within an existing communication group. For example, in an optimal situation all of the target devices within the received managerial group would be included in a single communication group, such that the associated command could then be transmitted to the relevant communication group. However, in some instances, the target devices associated with the received managerial group may be associated with multiple communication groups. Regardless, finding an optimal set of communication groups alleviates the need to send targeted unicast messages to a listing of target devices associated with the received managerial group.

As part of the evaluation, the group operator 102 may look first to determine which communication groups includes the most target devices from the received managerial group. While some devices within a communication group may not be target devices, the group operator 102 can select which devices within the communication group receive the message by selecting the targeted devices within the AddrMap. In other examples, communication groups may only be selected where all of the devices within the communication group are target devices associated with the received managerial group. By determining an optimal usage of communication groups for transmitting the received command to devices within the associated managerial group, the number of required transmissions by the group operator is reduced, thereby improving the time required to transmit the required command. While not described in detail above, it is understood that various statistical and probability analyses may be used to determine the optimal groupings.

At process block 708, the group operator determines whether the optimal groupings (i.e., optimal coverage) have been determined. In some examples, the group operator 102 determines that the optimal groupings have been determined based on determining that the minimal possible number of transmissions has been achieved. In other examples, the group operator 102 may dynamically determine when the optimal grouping has been achieved in view of a priority of the received command. For example, where the command is high priority, the group operator 102 may choose to minimally optimize (e.g., determine optimal groupings) to prevent unnecessary delays in transmitting the commands to the target devices. Thus, the group operator may vary the level of optimization based on various parameters, such as a priority of the received command.

In response to determining that the optimal groupings were not determined, the group operator 102 continues to evaluate the previously generated communication groups against the list of targets in the received managerial group to determine an optimal grouping of target devices within an existing communication group at process block 706. In response to determining that the optimal groupings were determined, the group operator 102 issues the received command to the target devices in the determined optimal communication groups. As noted above, in some instances, an entire communication group may include target devices. In other examples, the group operator 102 may only select target devices within a communication group to process the command transmitted to said communication group, such as by modifying the AddrMap of a given communication group.

At process block 712, the group operator 102 updates the list of targets to remove those targets that received the issued command. In some examples, upon finding the most optimal communication group, the command may first be issued to that group, which may not include all of the target devices associated with the received command. At process block 714, the group operator 102 determines whether any target devices remain (i.e., have not yet received the command). In response to determining that there are remaining target devices, the group operator returns to process block 706 to continue to evaluate optimal communication groups. This may include finding sub-optimal communication groups (e.g., communication groups that include fewer numbers of target device), and/or determining no optimal groups remain, which may result in sending targeted unicast messages to each remaining target device.

In response to determining that no target devices are remaining, the process 700 ends at process block 716.

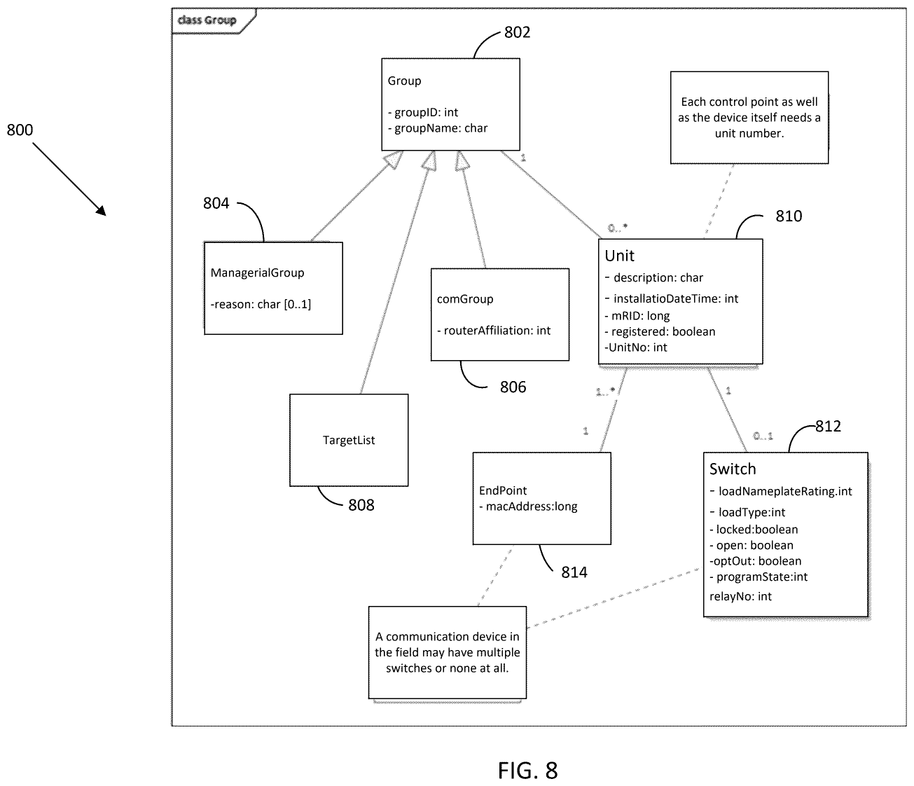

Turning now to FIG. 8, a class diagram 800 is shown, according to some embodiments. The class diagram illustrates the various attributes of various devices and structures described above. For example, for a general class of group 802, the group 802 may generically include a group ID and a group name. The group may be a managerial group 804 or a communication group 806, or a target list 808. The managerial group may include a reason field for identifying the purpose of the managerial group. The communication group 806 may include a router affiliation. One or more units 810 (e.g., devices) may be associated with each group 802. Units may consist of switches 812 (e.g., load devices) and endpoints 814 (e.g., meters). Units 810 generally include description fields, installation information fields, an mRID field, a registration field, and a UnitNo field. Switches 812 further include a load rating field, a load type field, a locked field, an open field, and opt out field, a program state field, and/or a relay number filed. Endpoints 814 may include a MAC address field. The above fields and classes are for exemplary purposes, and it should be noted that the various devices and structures described herein may include more or fewer fields, as required for a given application.

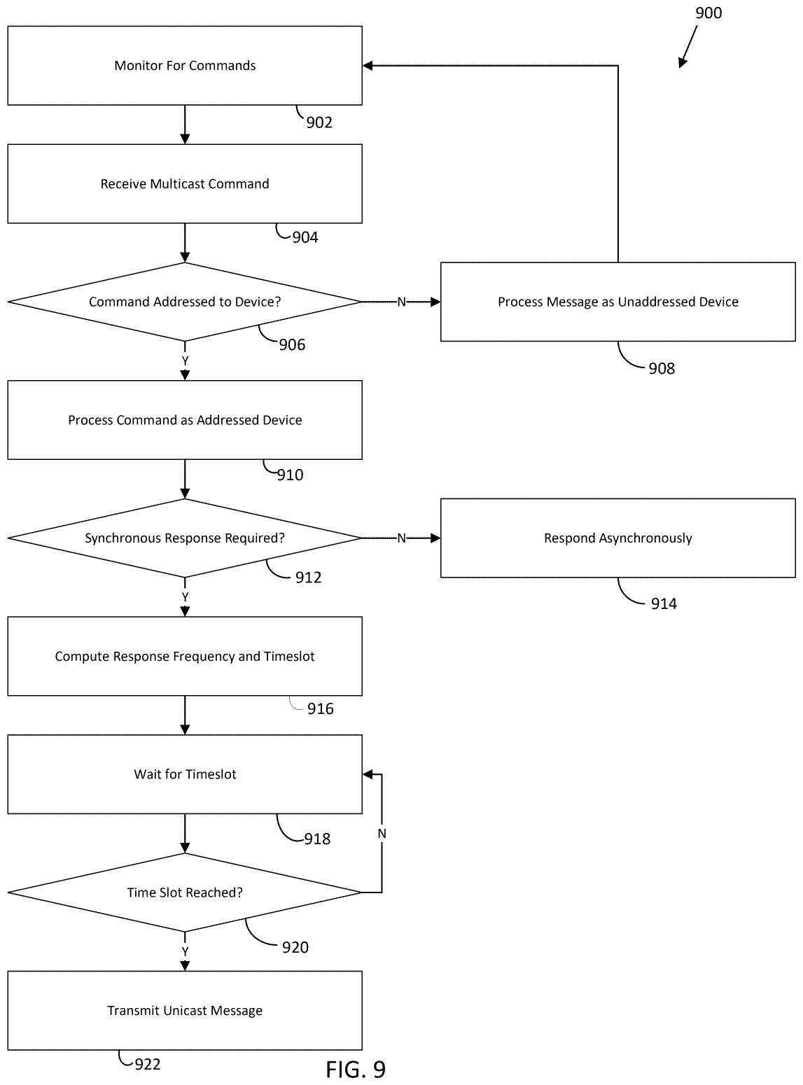

Turning now to FIG. 9, a process 900 for using application layer acknowledgement to allow for synchronous responses from one or more end point devices (e.g., meters 104 and/or load devices 106). In one embodiment, the process 900 is generally performed by an end device, such as a meter 104 and/or a load device 106. For purposes of brevity, the process 900 will generically be referred to as being performed by an end device. Where a synchronous response is required, addressed units (e.g., target devices) are to respond in a specific way within a specific time frame, as described below. Furthermore, in the event that synchronous responses are requested, this must also be understood by non-addressed units, as they must process the broadcasted message enough to know to refrain from transmitting on any frequency identified as part of the synchronous request, as described below. In contrast, where only asynchronous responses are required, each target device may respond in their own time.

Above, target devices are described as being addressed. A target device is “addressed” where a multicast broadcast delivers a message to the target device and there is no communication group restriction in the command. Alternatively, a target device may be “addressed” by a multicast broadcast delivering a message, wherein a command within the message specifies a particular communication group but no AddrMap, according to the following rule:

$$addressed = \{ \begin{matrix}TRUE , if comGroupID ∈ comGroupList \\ FALSE , otherwise\end{matrix} \qquad EQUATION 1$$

In a further alternative, a target device is “addressed” by a multicast broadcast delivering a message, wherein a command within the message specifies a particular communication group and AddrMap, according to the following rule:

$$addressed = \{ \begin{matrix}TRUE , if ( comGroupID ∈ comGroupList ) ⋀ ( AddrMap ( UnitNo ) == {}^{′} {1}^{′} ) \\ FALSE , otherwise\end{matrix}$$

EQUATION 2

In the above equations, comGroupList represents a list of all communication groups defined within the target device, and AddrMap( ) represents a bit array indexed so that a bit within the AddrMap corresponds to each UnitNo within the group.

Returning now to FIG. 9, at process block 902, the end device monitors for broadcast messages. At process block 904, the end device receives a multicast broadcast message. In one embodiment, the multicast broadcast message is received from the group operator 102. Upon receiving the multicast broadcast message, the end device determines whether the message is intended for the end device at process block 906. In one embodiment, the end device may determine whether the message is intended for the end device based on whether the end device is addressed in the message, as described above. In response to determining that the end device is not targeted, the end device then processes the received message to determine whether any restrictions are to be placed on the end device at process block 908. Restrictions may include determining whether the multicast broadcast requires a synchronous response, in which case the end device determines whether there are times and/or frequencies in which the end device is restricted from transmitting. While not described herein, it is understood that the end device may perform one or more other actions (or specifically not perform certain actions) based on the received message, as required for a given application.

In response to determining that the received message was targeted to the end device, the end device processes the command at process block 910. Processing the command may include determining one or more instructions within the received command. For example, processing the command may include determining what, if any, action is required, whether the command requires an asynchronous response or a synchronous response, and/or other information as required for a given application.

Upon processing the command, the end device determines whether a synchronous response or an asynchronous response is required, at process block 912. In one embodiment, the determination as to whether the response should be a synchronous response or an asynchronous response is based on data within the received message. In response to determining that an asynchronous response is required, the end device responds as needed at process block 914.

In response to determining that a synchronous response is required, the end device determines a required response frequency and timeslot for transmitting the response, at process block 916. In one embodiment, the received message may include a frequency mapping (“FreqMap”) element that identifies which inbound channels may be used to communicate the synchronous response. In the event that the FreqMap element is absent in the message, the end device may assume that any frequency is available. The end device may further determine a channel based on a number of viable channels (assumed to be, but not limited to, 32 as shown in Equation 3) provided in the FreqMap element using Equation 3:

$$c h Q t y = {\sum }_{i = 0}^{31} F r e q M a p ( i ) \qquad EQUATION 3$$

Based on the listing of available channels, the end device may determine a Unit Channel (UnitCh) for transmitting based on the following equation:

$$UnitCh = modulo ( AdjUnitNo , chQty ) \qquad EQUATION 4$$

The unit channel describes the frequency at which the transmission is to occur. A unit channel of zero indicates that the first frequency identified in FreqMap (marked with a ‘1’) corresponds to the entry in defined transmission frequency list. The transmission frequency may be determined based on the following equation, where phyTxFrequencies is simply a list or array of viable transmission frequencies.

$$frequency = phyTxFrequencies ( 1 + {\sum }_{i = 0}^{U n i t C h} F r e q M a p ( i ) ) \qquad EQUATION 5$$

The end device may then determine a timeslot for transmitting a response using the following equation:

$$TimeSlotNo = floor ( \frac{AdjUnitNo}{chQty} ) \qquad EQUATION 6$$

In one embodiment, the time at which the response should occur (timeslot) is given by the time at which the outbound command was captured, plus a start delay (“StartDelay”), plus a unit response window (“UnitResponseWindow”) multiplied by a timeslot number, as described per the below equation:

$$UnitDelay = StartDelay + UnitResponseWindow * TimeSlotNo \qquad EQUATION 7$$

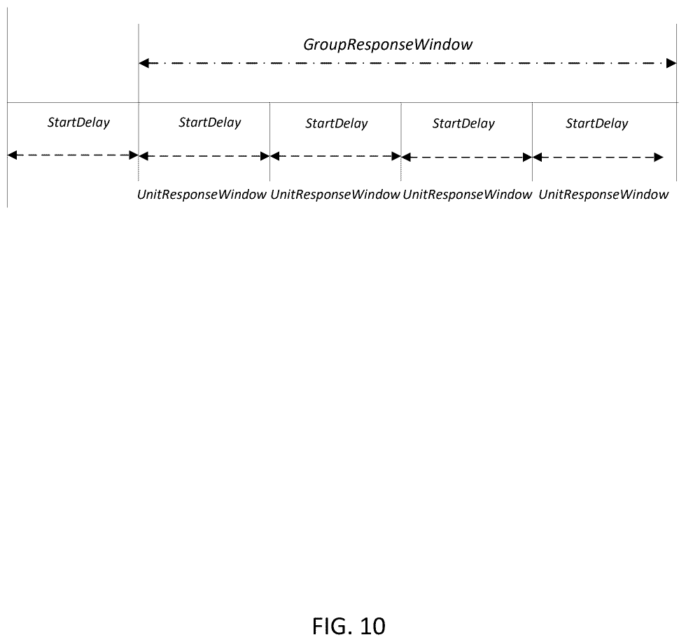

A relationship between response windows and start delays, as calculated above, is shown in FIG. 10. Returning again to FIG. 9, upon computing the response frequency and timeslot, the end device waits for the determined timeslot at process block 918. At process block 920, the end device determines whether the time slot has been reached. In response to determining the that the timeslot has not been reached, the end device continues to wait for the time slot at process block 918. In response to determining that the timeslot has been reached, the end device transmits the unicast message at process block 922.

Multiple end device may be expected to transmit in each timeslot, and therefore the frequency that is used is based on a Unit Number of the end device, as shown in Table 1, below.

TABLE 1

| | |
|---|---|
| Channel | |
| Number | Unit Number |

| | | | | | |
|---|---|---|---|---|---|
| 3 | 3 | 7 | 11 | 15 | |
| 2 | 2 | 6 | 10 | 14 | |
| 1 | 1 | 5 | 9 | 13 | |
| 0 | 0 | 4 | 8 | 12 | |
| | 0 | 1 | 2 | 3 | Timeslot |
| | | | | | Number |

In some examples, the Unit Numbers may need to be adjusted when an AddrMap associated with a group includes zeros (i.e., indicating that some devices within the group are not targeted). To do so, the end device must analyze a received AddrMap and count the number of ‘1’s beginning with a least significant bit. Upon counting the ‘1’s, the end device reaches its assigned Unit Number (to also find a ‘1’ within the AddrMap), and the end devices adjusted Unit No (“AdjUnitNo”) becomes the number of ‘1’s counted which are less than the end device's Unit No, as described in the below equation.

$$AdjUnitNo = ( {\sum }_{i = 0}^{i = U n i t N o} A d d r M a p ( i ) ) - 1 \qquad EQUATION 8$$

This may affect the timeslot determination, as shown in Table 2, below.

TABLE 2

| | |
|---|---|
| Channel | |
| Number | AdjUnitNo |

| | | | | | |
|---|---|---|---|---|---|
| 3 | 3 | 7 | 11 | 15 | |
| 2 | 2 | 6 | 10 | 14 | |
| 1 | 1 | 5 | 9 | 13 | |
| 0 | 0 | 4 | 8 | 12 | |
| | 0 | 1 | 2 | 3 | Timeslot |
| | | | | | Number |

Various features and advantages of the invention are set forth in the following claims.

What is claimed is:

1. A utility system, comprising:
a plurality of electrical meters;
a plurality of load devices; and
a utility controller, the utility controller configured to:
receive a command and an associated managerial group;
determine a plurality of target devices based on the received managerial group, wherein the target devices include one or more of the plurality of electrical meters and one or more of the plurality of load devices;
determine a first optimal communication group of a plurality of communication groups associated with the utility system, wherein the first optimal communication group includes one or more of the plurality of determined target devices; and
issue the received command to the determined optimal communication group.

2. The system of claim 1, wherein the plurality of communication groups include one or more of the plurality of electrical meters and one or more of the plurality of load devices.

3. The system of claim 1, wherein the utility controller is further configured to:
determine whether any of the plurality of target devices were not included in the optimal communication group; and
determine a second optimal communication group, wherein the second optimal communication group includes one or more of the plurality of target devices not included in the first optimal communication group.

4. The system of claim 1, wherein the first optimal communication group includes a largest quantity of the plurality of target devices.

5. The system of claim 1, wherein the command and an associated managerial group are transmitted by a third-party device.

6. The system of claim 1, wherein the command includes an instruction to respond to the command using synchronous communication.

7. The system of claim 6, wherein synchronous communication requires each of the target devices to transmit a response at a predefined frequency and timeslot.

8. The system of claim 1, wherein the utility controller performs a union and intersection operation to determine the optimal communication group.

9. A method for issuing commands to devices within a utility system, comprising:
receiving a command at a utility controller, wherein the command includes a grouping of target devices within a utility system to execute the command;
determining, at the utility controller, a plurality of target devices within the utility system based on the received command; and
determining a first optimal communication group of a plurality of communication groups associated with the utility system, wherein the first optimal communication group includes one or more of the plurality of determined target devices.

10. The method of claim 9, wherein the plurality of communication groups include one or more of a plurality of electrical meters and one or more of a plurality of load devices.

11. The method of claim 9, further comprising:
determining whether any of the plurality of target devices were not included in the optimal communication group;
determining a second optimal communication group, wherein the second optimal communication group includes one or more of the plurality of target devices not included in the first optimal communication group; and
transmitting the issued received command to the second optimal communication group.

12. The method of claim 9, wherein the first optimal communication group includes a largest number of the plurality of target devices.

13. The method of claim 9, wherein the command is transmitted by an external device.

14. The method of claim 9 wherein the command includes an instruction to respond to the command using synchronous communication.

15. The method of claim 14, wherein synchronous communication requires each of the target devices to transmit a response at a predefined frequency and timeslot.

16. A utility device, comprising:
a communication interface; and
an electronic processor configured to:
receive a command via the communication interface;
determine whether the received command is addressed to the utility device;
process the command in response to determining that the received command is addressed to the utility device;
determine whether the command requires a synchronous response;
determine a response frequency and timeslot for responding to the command in response to determining that the command requires a synchronous response;
determine whether the determined timeslot has occurred; and
transmitting a response via the communication interface to the command in response to determining the timeslot has occurred.

17. The utility device of claim 16, wherein the utility device is configured to refrain from transmitting on the response frequency during the timeslot in response to determining that the command is not addressed to the utility device.

18. The utility device of claim 16, wherein the utility device is a load switching device.

19. The utility device of claim 16, wherein the utility device is an electrical meter.

20. The utility device of claim 16, wherein the command is received from a utility controller.
